(19) United States
(12) Patent Application Publication
(10) Pub. No.: US 2026/0356095 A1
(43) Pub. Date: Nov. 12, 2026

(54) LIQUID EJECTING HEAD

(71) Applicant: SEIKO EPSON CORPORATION, Tokyo (JP)

(72) Inventors: Takahiro KATAKURA, OKAYA-SHI (JP); Takanori AIMONO, SHIOJIRI-SHI (JP); Mitsuki EBISAWA, SHIOJIRI-SHI (JP); Yuma MORIYA, MATSUMOTO-SHI (JP); Manabu TANIGUCHI, SHIOJIRI-SHI (JP); Daichi YATAGAI, MATSUMOTO-SHI (JP)

(21) Appl. No.: 19/563,370

(22) Filed: Mar. 11, 2026

(30) Foreign Application Priority Data
Mar. 13, 2025 (JP) 2025-040366

(51) Int. Cl. B41J 2/14; C09D 11/36

(52) U.S. Cl. CPC B41J 2/1433; B41J 2/14233; C09D 11/36; B41J 2002/14475; B41J 2202/03; B41J 2202/11

(57) ABSTRACT

A liquid ejecting head includes a nozzle substrate having a nozzle configured to eject a liquid, wherein a direction in which the liquid is ejected from the nozzle is an ejection direction, the nozzle substrate has a projecting portion along a periphery of an opening of the nozzle on a surface facing the ejection direction, and the nozzle has a plurality of protruding portions that protrude toward a central axis of the nozzle from an inner side surface that is a portion of a side surface along the ejection direction.

The present application is based on, and claims priority from JP Application Ser. No. 2025-040366, filed Mar. 13, 2025, the disclosure of which is hereby incorporated by reference herein in its entirety.

### BACKGROUND

### 1. Technical Field

The present disclosure relates to a liquid ejecting head.

### 2. Related Art

JP-A-2020-147641 describes an ink jet head using a water-based ink composition having a surface tension in a range of 20 to 30 mN/m.

When a liquid droplet ejected from the nozzle forms a tail, the liquid droplet separates into a leading main droplet and a trailing satellite droplet. When the satellite droplet lands at a position different from the landing position of the main droplet on a landing target such as a recording medium, the image quality of a recorded image may be deteriorated.

In recent years, because of diversification of ink, ink having a low surface tension is used in some cases. In the related art, for example, when ink having a low surface tension, such as one disclosed in JP-A-2020-147641, is used, liquid droplets attached to the front face of the nozzle substrate having nozzles are likely to spread. Thus, the ejected liquid droplets are affected and bent by the liquid spread unevenly around the nozzles, causing a straightness problem. That is, it has been desired to solve both the problem of satellite droplets generated by the tailing and the straightness problem of liquid droplets.

### SUMMARY

According to an embodiment of the present disclosure, a liquid ejecting head includes a nozzle substrate having a nozzle configured to eject a liquid, wherein a direction in which the liquid is ejected from the nozzle is an ejection direction, the nozzle substrate has a projecting portion along a periphery of an opening of the nozzle on a surface facing the ejection direction, and the nozzle has a plurality of protruding portions that protrude toward a central axis of the nozzle from an inner side surface that is a portion of a side surface along the ejection direction.

### BRIEF DESCRIPTION OF THE DRAWINGS

FIG. 1 is a schematic view illustrating a configuration example of a liquid ejecting apparatus including a liquid ejecting head.

FIG. 2 is an exploded perspective view of a liquid ejecting head according to a first embodiment.

FIG. 3 is a cross-sectional view taken along line III-III in FIG. 2.

FIG. 4 is a view of a nozzle according to the first embodiment viewed in a direction opposite the ejection direction.

FIG. 5 is a cross-sectional view taken along line V-V in FIG. 4.

FIG. 6 is a cross-sectional view taken along line VI-VI in FIG. 4.

FIG. 7 is a view of a nozzle according to a second embodiment viewed in a direction opposite the ejection direction.

FIG. 8 is a cross-sectional view taken along line VIII-VIII in FIG. 7.

FIG. 9 is a cross-sectional view of a nozzle according to a third embodiment.

FIG. 10 is a view of a nozzle according to a first modification viewed in a direction opposite the ejection direction.

### DESCRIPTION OF EMBODIMENTS

Hereinafter, preferred embodiments according to the present disclosure will be described with reference to the accompanying drawings. In the drawings, the dimensions and scale of each portion are different from the actual one as appropriate, and some portions are schematically illustrated for ease of understanding. In addition, the scope of the present disclosure is not limited to the following configurations unless otherwise specified in the following description as limiting the present disclosure.

In the following description, for convenience, the X axis, Y axis, and Z axis that intersect each other are appropriately used. In the following, one direction along the X axis is an X1 direction, and a direction opposite to the X1 direction is an X2 direction. Similarly, the directions opposite to each other along the Y axis are a Y1 direction and a Y2 direction. One of the Y1 direction and the Y2 direction is an example of a “first direction.” In addition, the directions opposite to each other along the Z axis are a Z1 direction and a Z2 direction. The Z1 direction is an example of a “second direction.” In the following, viewing in the Z1 direction or the Z2 direction may be referred to as “plan view.”

Here, typically, the Z axis is a vertical axis, and the Z2 direction corresponds to a downward direction in the vertical direction. The Z axis does not necessarily have to be the vertical axis. The X axis, the Y axis, and the Z axis are typically orthogonal to each other, but are not limited to this, and need only intersect each other at, for example, an angle in a range of, for example, 80 °or more and 100 °or less.

### 1. FIRST EMBODIMENT

### 1-1: Overall Configuration of Liquid Ejecting Apparatus

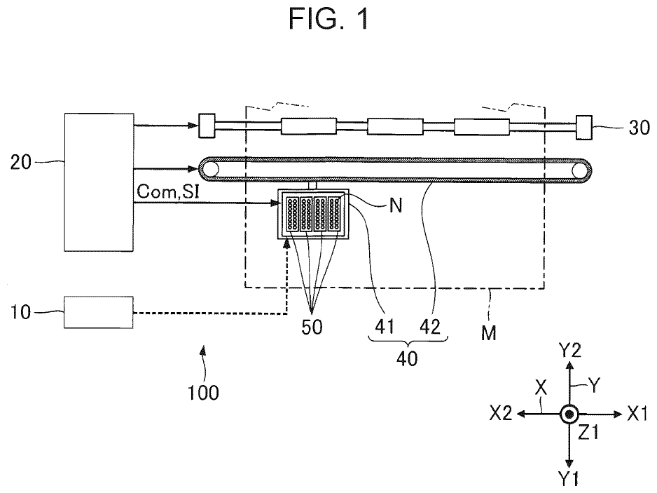

FIG. 1 is a schematic view illustrating a configuration example of a liquid ejecting apparatus 100 including a liquid ejecting head 50. The liquid ejecting apparatus 100 is an ink jet printing apparatus that ejects ink, which is an example of a “liquid,” in the form of liquid droplets toward a recording medium M. For example, the recording medium M is a print sheet. The recording medium M is not limited to the print sheet, and may be, for example, a printing target of any material such as a resin film or a cloth.

As illustrated in FIG. 1, the liquid ejecting apparatus 100 includes a liquid container 10, a control module 20, a transport mechanism 30, a movement mechanism 40, and a plurality of liquid ejecting heads 50.

The liquid container 10 stores ink. Specific aspects of the liquid container 10 include, for example, a cartridge that can be attached to and detached from the liquid ejecting apparatus 100, a bag-shaped ink pack formed of a flexible film, and an ink tank refillable with ink. The type of ink stored in the liquid container 10 is appropriately determined.

The control module 20 controls an operation of each component of the liquid ejecting apparatus 100. For example, the control module 20 includes a processing circuit, such as a central processing unit (CPU) and a field programmable gate array (FPGA), and a storage circuit, such as a semiconductor memory. Here, the control module 20 outputs a drive signal Com for driving the liquid ejecting head 50 and a control signal SI for controlling the drive of the liquid ejecting head 50. The control module 20 controls an ejection operation from the liquid ejecting head 50 by using the drive signal Com and the control signal SI.

The transport mechanism 30 transports the recording medium M along the Y axis under the control of the control module 20.

The movement mechanism 40 reciprocates the liquid ejecting head 50 along the X axis under the control of the control module 20. The movement mechanism 40 includes a carriage 41, which accommodates the liquid ejecting head 50, and an endless transport belt 42 to which the carriage 41 is fixed. In addition to the liquid ejecting head 50, the above-described liquid container 10 may be mounted on the carriage 41.

Each of the liquid ejecting heads 50 ejects the ink supplied from the liquid container 10 onto the recording medium M from each of a plurality of nozzles N under the control of the control module 20. The ejection is performed in parallel with the transport of the recording medium M by the transport mechanism 30 and the reciprocating movement of the liquid ejecting head 50 by the movement mechanism 40, and thus an image is formed by the ink on a surface of the recording medium M.

In the example illustrated in FIG. 1, the number of liquid ejecting heads 50 is four. The number of liquid ejecting heads 50 is not limited to the example illustrated in FIG. 1, and may be any number such as three or less and five or more. Furthermore, the arrangement of the liquid ejecting heads 50 is not limited to the example illustrated in FIG. 1 and is appropriately determined.

### 1-2: Liquid Ejecting Head

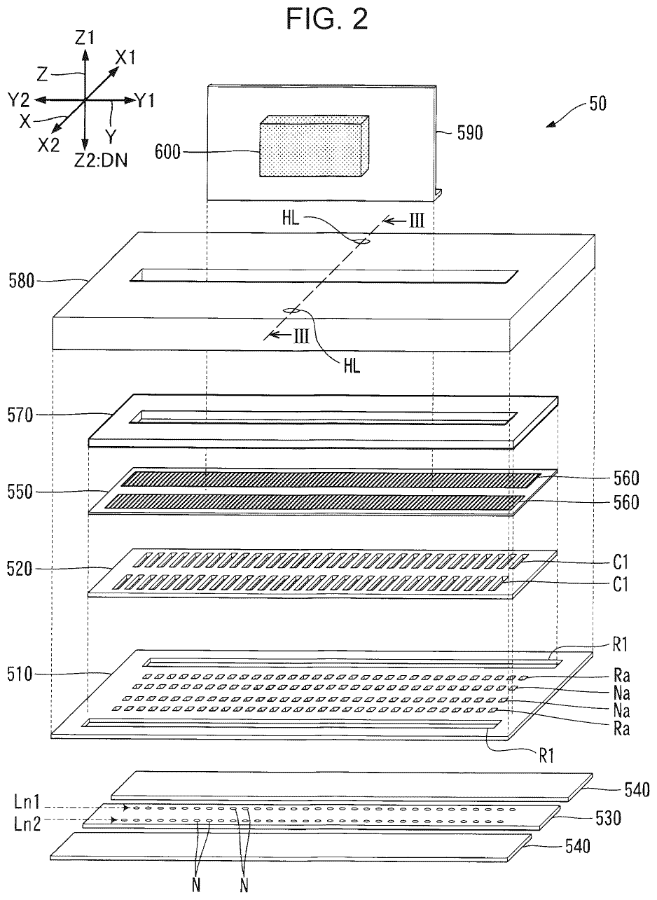

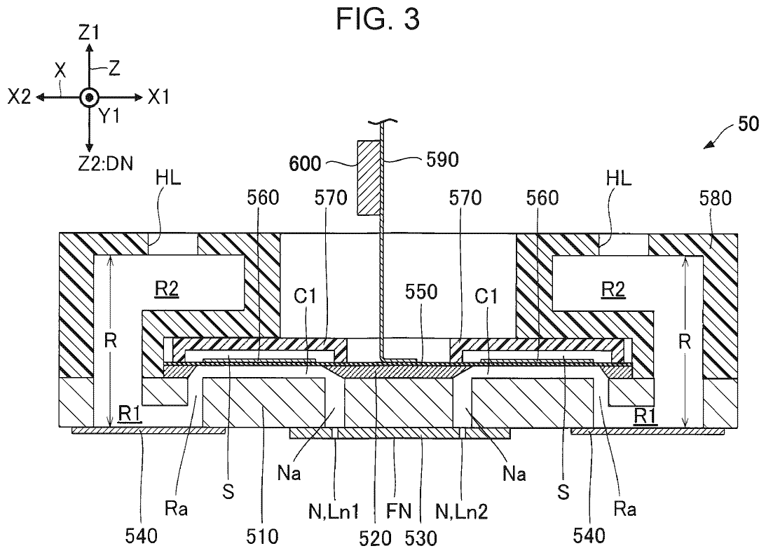

FIG. 2 is an exploded perspective view of the liquid ejecting head 50 according to the first embodiment. FIG. 3 is a cross-sectional view taken along line III-III in FIG. 2.

Hereinafter, an example of the configuration of the liquid ejecting head 50 will be described.

As illustrated in FIGS. 2 and 3, the liquid ejecting head 50 has a plurality of nozzles N for ejecting ink in an ejection direction DN. In this embodiment, the ejection direction DN is the Z2 direction.

The nozzles N included in the liquid ejecting head 50 are divided into a first nozzle row Ln1 and a second nozzle row Ln2 away from each other in the direction along the X axis. Each of the first nozzle row Ln1 and the second nozzle row Ln2 is a set of the nozzles N linearly arranged in the direction along the Y axis.

The liquid ejecting head 50 is substantially symmetrical in the direction along the X axis. However, positions of the nozzles N of the first nozzle row Ln1 and positions of the nozzles N of the second nozzle row Ln2 in the direction along the Y axis may coincide with each other or may be different from each other. FIGS. 2 and 3 illustrate a configuration in which the positions of the nozzles N of the first nozzle row Ln1 and the positions of the nozzles N of the second nozzle row Ln2 coincide with each other in the direction along the Y axis.

As illustrated in FIGS. 2 and 3, the liquid ejecting head 50 includes a communication substrate 510, a pressure chamber substrate 520, a nozzle substrate 530, a vibration absorber 540, a vibration plate 550, a plurality of piezoelectric elements 560, a protective substrate 570, a case 580, and a wiring substrate 590.

The communication substrate 510 and the pressure chamber substrate 520 are stacked in this order in the Z1 direction and form a flow path for supplying ink to the nozzles N. In a region located in the Z1 direction from the stack of the communication substrate 510 and the pressure chamber substrate 520, the vibration plate 550, the piezoelectric elements 560, the protective substrate 570, the case 580, the wiring substrate 590, and the drive circuit 600 are disposed. In contrast, the nozzle substrate 530 and the vibration absorber 540 are disposed in a region located in the Z2 direction from the stack. The components of the liquid ejecting head 50 are generally plate-like members elongated in a direction along the Y axis and are bonded to each other with, for example, an adhesive. Hereinafter, the components of the liquid ejecting head 50 will be described in order.

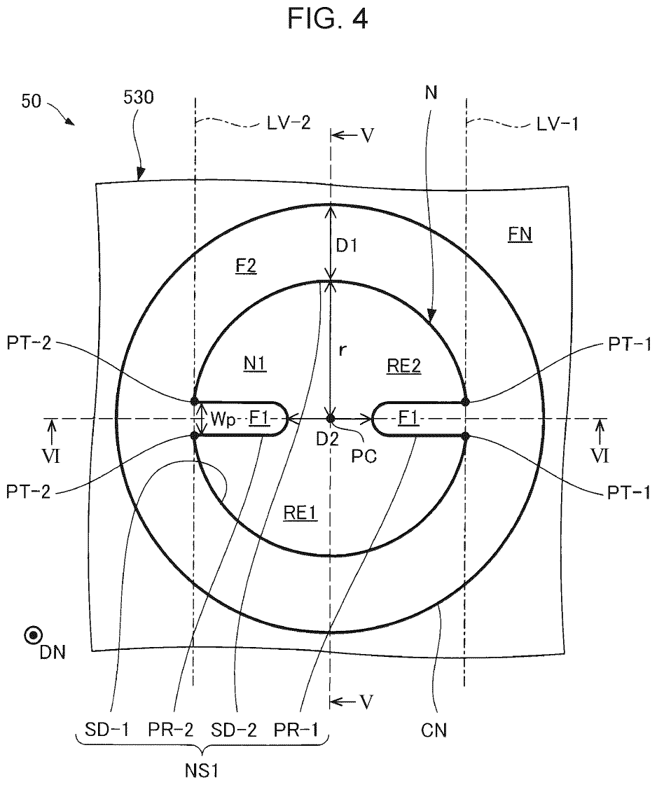

The nozzle substrate 530 is a plate-shaped member having the nozzles N of the first nozzle row Ln1 and the second nozzle row Ln2. Each of the plurality of nozzles N is a through hole through which ink is passed. Here, the surface of the nozzle substrate 530 facing the Z2 direction is a nozzle surface FN. The nozzle substrate 530 is, for example, a silicon substrate, and the nozzle substrate 530 is manufactured by processing a silicon single crystal substrate by a semiconductor manufacturing technique using a processing technique such as dry etching or wet etching. Other known methods and materials may be appropriately used for manufacturing the nozzle substrate 530. Furthermore, the nozzle substrate 530 is not limited to the silicon substrate, and may be, for example, a resin film. The cross-sectional shape of the nozzle N is an irregular shape different from a circular shape. Details of the nozzle N will be described later with reference to FIGS. 4 to 6.

The communication substrate 510 has a flow path R1, a plurality of supply flow paths Ra, and a plurality of communication flow paths Na for each of the first nozzle row Ln1 and the second nozzle row Ln2. The flow path R1 is a flow path which is provided in common for the plurality of nozzles N, is in communication with the nozzles N, is located upstream of the nozzles N, and is formed of an elongated hole extending in the direction along the Y axis in plan view viewed in the direction along the Z axis. Each of the supply flow paths Ra and the communication flow paths Na is a flow path formed of a through hole provided for each of the nozzles N. The supply flow paths Ra are in communication with the flow path R1.

The communication substrate 510 is manufactured by, for example, processing a silicon single crystal substrate by using a semiconductor manufacturing technique, similarly to the nozzle substrate 530 described above. However, other known methods and materials may be appropriately used for manufacturing the communication substrate 510.

The pressure chamber substrate 520 is a plate-shaped member in which a plurality of pressure chambers C1, which are called cavities, are provided for each of the first nozzle row Ln1 and the second nozzle row Ln2. The pressure chambers C1 are arranged in the direction along the Y axis. Each pressure chamber C1 is an elongated space formed for a corresponding one of the nozzles N and extending in a direction along the X axis in plan view. The pressure chamber C1 is filled with the liquid to be ejected from the nozzle N.

The pressure chamber substrate 520 is manufactured by, for example, processing a silicon single crystal substrate by a semiconductor manufacturing technique, similarly to the nozzle substrate 530 described above. However, other known methods and materials may be appropriately used for manufacturing the pressure chamber substrate 520.

The pressure chambers C1 are located between the communication substrate 510 and the vibration plate 550. The pressure chambers C1 are arranged in the direction along the Y axis for each of the first nozzle row Ln1 and the second nozzle row Ln2. In addition, the pressure chamber C1 is in communication with each of the communication flow path Na and the supply flow path Ra. Thus, the pressure chamber C1 is in communication with the nozzle N through the communication flow path Na and is in communication with the flow path R1 through the supply flow path Ra.

The vibration plate 550 is disposed on the pressure chamber substrate 520, more specifically, on a surface facing the Z1 direction of the pressure chamber substrate 520. The vibration plate 550 is a plate-shaped member that can be elastically vibrated and is vibrated by the piezoelectric element 560. Although not illustrated, for example, the vibration plate 550 includes an elastic film formed of silicon oxide (SiO₂) and an insulating film formed of zirconium oxide (ZrO₂), and these films are stacked in this order in the Z1 direction. For example, the elastic film is formed by thermally oxidizing one surface of a silicon single crystal substrate. The insulating film is formed, for example, by forming a zirconium layer by a sputtering method and then thermally oxidizing the layer. The vibration plate 550 is not limited to the above-described multilayer structure including the elastic film and the insulating film and may be formed of, for example, a single layer or three or more layers.

The piezoelectric elements 560 corresponding to the nozzles N are disposed on a surface of the vibration plate 550 facing the Z1 direction for each of the first nozzle row Ln1 and the second nozzle row Ln2. Each piezoelectric element 560 is a passive element that is deformed by the supply of a potential corresponding to the drive signal Com and causes pressure fluctuation in the ink in the pressure chamber C1. In this way, the piezoelectric elements 560 are driven by the drive signal Com, and the volumes of the pressure chambers C1 change in response to the driving of the piezoelectric elements 560. Each of the piezoelectric elements 560 has a shape elongated in the direction along the X axis in plan view. The piezoelectric elements 560 are arranged in a direction along the Y axis so as to correspond to the pressure chambers C1. The piezoelectric elements 560 overlap the pressure chambers C1 in plan view. The above-described piezoelectric elements 560 apply pressures to the pressure chambers C1 in communication with the nozzles N that eject the ink.

Although not illustrated, each of the piezoelectric elements 560 includes, for example, a first electrode, a piezoelectric body, and a second electrode, which are stacked in this order in the Z1 direction. One of the first electrode and the second electrode is an individual electrode, which is arranged apart from other electrodes for each of the piezoelectric elements 560, and a drive signal Com is supplied to the one electrode from the control module 20. The other electrode of the first electrode and the second electrode is a band-shaped common electrode, which continuously extends in the direction along the Y axis over the piezoelectric elements 560, and, for example, a constant potential is supplied to the other electrode. Examples of the metal material of the electrodes include metal materials, such as platinum (Pt), aluminum (Al), nickel (Ni), gold (Au), and copper (Cu). These materials may be used alone or in combination in an alloyed or stacked manner. The piezoelectric body is formed of a piezoelectric material such as lead zirconate titanate (Pb(Zr, Ti)O₃). The piezoelectric body may be integrally provided over the piezoelectric elements 560 or may be individually provided for each piezoelectric element 560.

The protective substrate 570 is a plate-shaped member disposed on the surface of the vibration plate 550 facing the Z1 direction to protect the piezoelectric elements 560 and to reinforce the mechanical strength of the vibration plate 550. Here, the piezoelectric elements 560 are accommodated in a space S between the protective substrate 570 and the vibration plate 550. The protective substrate 570 is formed of, for example, a resin material.

The case 580 is a case for storing ink to be supplied to the pressure chambers C1. For example, the case 580 is formed of a resin material. The case 580 has a flow path R2 for each of the first nozzle row Ln1 and the second nozzle row Ln2. The flow path R2 is a space connected to the above-described flow path R1 and is an elongated hole extending in the direction along the Y axis in plan view viewed in the direction along the Z axis. The flow path R2 is in communication with the nozzle N and functions as a reservoir R that stores the ink supplied to the pressure chambers C1 together with the flow path R1. The case 580 has an inlet HL for supplying the ink to each reservoir R. The ink in each reservoir R is supplied to the pressure chamber C1 via the supply flow path Ra. The positions, the number, and other aspects of the inlets HL for each reservoir R are not limited to the examples illustrated in FIGS. 2 and 3, and are appropriately determined.

The vibration absorber 540, also referred to as a compliance substrate, is a flexible resin film constituting a wall surface of the reservoir R and absorbs the pressure fluctuation of the ink in the reservoir R. The vibration absorber 540 may be a flexible thin plate formed of metal. A surface of the vibration absorber 540 facing the Z1 direction is attached to the communication substrate 510 with an adhesive or the like.

The wiring substrate 590 is mounted on the surface of the vibration plate 550 facing the Z1 direction and is a mounting component that electrically couples the control module 20 and the liquid ejecting head 50. For example, the wiring substrate 590 is a flexible wiring substrate, such as a chip on film (COF), a flexible printed circuit (FPC), and a flexible flat cable (FFC). The drive circuit 600 is mounted on the wiring substrate 590 of the present embodiment. The drive circuit 600 switches whether or not to supply a pulse included in the drive signal Com output from the control module 20 to each of the piezoelectric elements 560 of the liquid ejecting head 50 under the control of the control module 20. As described above, the wiring substrate 590 supplies the drive signal Com for driving the piezoelectric element 560. The wiring substrate 590 may be a rigid substrate. In this case, the drive circuit 600 is mounted on the rigid substrate or a flexible substrate coupled to the rigid substrate.

### 1-3: Nozzle

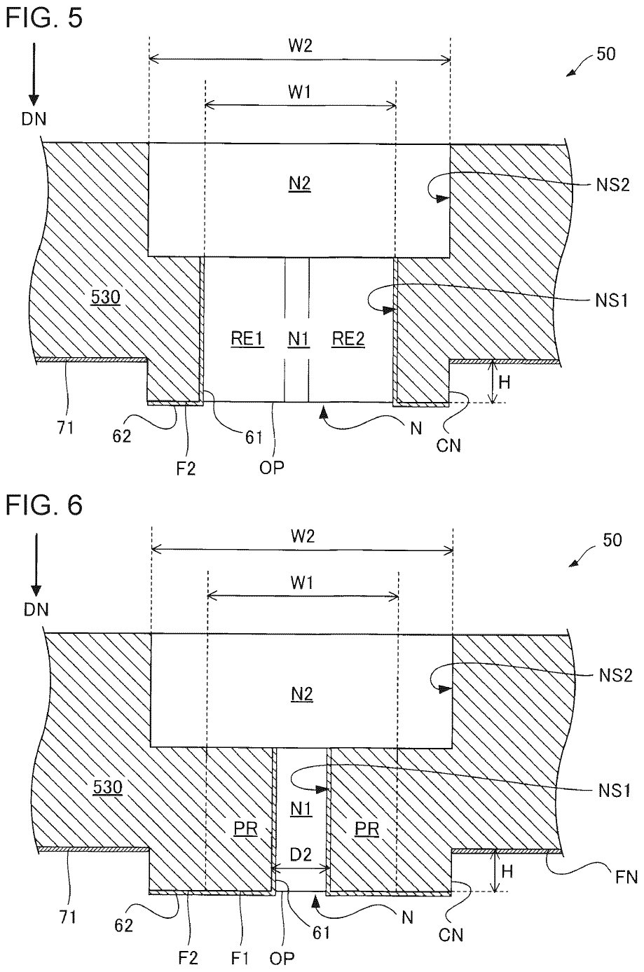

FIG. 4 is a view of the nozzle N according to the first embodiment viewed in a direction opposite the ejection direction DN. FIG. 5 is a cross-sectional view taken along line V-V in FIG. 4. FIG. 6 is a cross-sectional view taken along line VI-VI in FIG. 4. FIG. 5 is a cross-sectional view passing through an inner side surface SD described later, and FIG. 6 is a cross-sectional view passing through a protruding portion PR described later.

As illustrated in FIGS. 4 to 6, the nozzle N includes a first nozzle section N1 and a second nozzle section N2. The second nozzle section N2 and the first nozzle section N1 are arranged in this order in the ejection direction DN. In the illustrated example, the first nozzle section N1 and the second nozzle section N2 are adjacent to each other.

The first nozzle section N1 is a hole in the nozzle surface FN of the nozzle substrate 530 and through which ink is ejected. The first nozzle section N1 is defined by a side surface NS1 extending in the ejection direction DN. As illustrated in FIG. 4, the side surface NS1 of the first nozzle section N1 includes inner side surfaces SD-1 and SD-2 and protruding portions PR-1 and PR-2. Hereinafter, when the inner side surfaces SD-1 and SD-2 do not need to be distinguished from each other, the inner side surfaces SD-1 and SD-2 are each referred to as an inner side surface SD. When the protruding portions PR-1 and PR-2 do not need to be distinguished from each other, the protruding portions PR-1 and PR-2 are each referred to as a protruding portion PR.

The protruding portions PR-1 and PR-2, which are a plurality of protruding portions PR (a pair of protruding portions in this embodiment), are protrusions protruding toward the central axis PC of the nozzle N from the inner side surface SD and extend in the ejection direction DN. In the illustrated example, each protruding portion PR extends in the ejection direction DN over the entire region in the ejection direction DN of the first nozzle section N1. This configuration in which the nozzle N has the plurality of protruding portions PR locally increases the Laplace pressure of the meniscus located between the protruding portions PR at the time of ejection, shortening the length of the tail at the time of ejection.

In the first nozzle section N1 having such a shape including the pair of protruding portions PR, two tangential lines that are tangent to an outer periphery of the first nozzle section N1 at respective points in plan view can be drawn. When one of the two tangential lines is a virtual straight line LV-1 and the other tangential line is a virtual straight line LV-2, the two points at which the virtual straight line LV-1 is tangent to the outer periphery of the first nozzle section N1 are points PT-1, and the two points at which the virtual straight line LV-2 is tangent to the outer periphery of the first nozzle section N1 are points PT-2. The protruding portion PR-1 is a portion between the two points PT-1 of the side surface NS1, and the protruding portion PR-2 is a portion between the two points

### Pt-2 of the Side Surface Ns1.

The virtual straight line LV-2 is a straight line different from the virtual straight line LV-1. In the illustrated example, the virtual straight line LV-1 and the virtual straight line LV-2 are parallel to each other.

The first nozzle section N1 is divided into a first region RE1 and a second region RE2 in plan view by the protruding portions PR-1 and PR-2. That is, when the first nozzle section N1 is seen in plan view, the first nozzle section N1 is divided into the first region RE1 and the second region RE2 with the pair of protruding portions PR interposed therebetween. In the illustrated example, each of the first region RE1 and the second region RE2 has a shape along a semicircle. In this configuration, since each of the regions divided by the protrusion portion PR is a semicircle, the liquid droplet ejected from each region has a stable shape on the side remote from the protruding portion PR and has an unstable shape on the side close to the protruding portion PR. This configuration allows the liquid ejected from the regions to be united on the protruding portion PR side, and thus the liquid droplets are not easily separated.

The inner side surface SD is a portion of the side surface NS1. Here, the inner side surface SD-1 is a portion between the point PT-1 and the point PT-2 of the side surface NS1 in the first region RE1 in plan view. The inner side surface SD-2 is a portion of the side surface NS1 between the point PT-1 and the point PT-2 in the second region RE2 in plan view.

A wettable film 61 having wettability is provided on the side surface NS1. In the example illustrated in FIGS. 5 and 6, the wettable film 61 is provided over the entire area of the side surface NS1. Thus, the wettable film 61 is provided on both the inner side surface SD and the protruding portion PR.

Here, the protruding portions PR each have the wettable film 61 having wettability at positions where the protrusion portions PR face each other. This configuration, in which the wettable film 61 is provided at the positions where the protruding portions PR face each other, can stabilize the position of meniscus between the protruding portions PR.

The term “wettable” means that the contact angle with pure water is less than 70 °. A constituent material of the wettable film 61 is not particularly limited as long as it can provide wettability. Examples of the material include a monomolecular film having a hydroxy group or a carboxy group at a terminal and PPSi (polysiloxane). The wettable film 61 is preferably formed of a material that exhibits wettability with respect to ink. For example, it is preferable that the angle of contact between the ink having a surface tension of about 25 mN/m and the wettable film 61 be less than 40 °.

In addition, between the wettable film 61 and the surface of the nozzle substrate 530, a protective layer formed of tantalum oxide or the like or an adhesion layer such as a silicon plasma polymerization film may be provided.

The nozzle surface FN, which is a surface facing the ejection direction DN of the nozzle substrate 530, has the projecting portion CN projecting in the ejection direction DN. The projecting portion CN is provided along the periphery of the opening of the nozzle N. Thus, the nozzle N is open in a surface F2 (leading end surface) of the projecting portion CN, which is facing the ejection direction DN. In the illustrated example, the projecting portion CN has an annular shape surrounding the opening of the nozzle N in plan view. In addition, the surface F2 of the projecting portion CN facing the ejection direction DN is parallel to the nozzle surface FN. In this embodiment, the surfaces F1 of the protruding portions PR facing the ejection direction DN are continuous with the surface F2 of the projecting portion CN facing the ejection direction DN and are flush with each other.

With this configuration, when a liquid wet-spread to the periphery of the opening of the nozzle N, the projecting portion CN, which is provided on the nozzle surface FN along the periphery of the opening of the nozzle N, can stop the wet-spreading. Even when the surface tension of the liquid is low, this configuration can reduce the possibility that the liquid will wet-spread from the opening of the nozzle N along the surface of the nozzle substrate 530.

In addition, even when the mist of the liquid is attached to the periphery of the opening of the nozzle N, the projecting portion CN, which is provided along the periphery of the opening of the nozzle N on the surface facing the ejection direction DN of the nozzle substrate 530, limits the area in which the mist wet-spread.

Furthermore, since the projecting portion CN is provided, it is possible to intentionally form a liquid pool on the surface F2 of the projecting portion CN facing the ejection direction DN. The projecting portion CN, which is provided around the opening of the nozzle N, allows the liquid pool to be uniformly formed along the opening of the nozzle N.

With this configuration, when a liquid droplet or mist attaches to the periphery of the opening of the nozzle N, the liquid droplet or mist uniformly wet-spreads along the projecting portion CN. This reduces the possibility that the droplet ejected from the nozzle N will be bent by the attached droplet or mist. That is, this configuration enables the liquid droplets ejected from the nozzles N to keep the straightness.

Here, in a case where the surface tension of the liquid ejected from the nozzle N is 10 mN/m or more and 30 mN/m or less, the effect provided by the projecting portion CN is significant. That is, even when such a liquid having a low surface tension is used, the projecting portion CN can reduce the possibility that the liquid will wet-spread along the surface of the nozzle substrate 530. In addition, when such a liquid having a low surface tension is used, a liquid pool in a uniform wet state is likely to be formed on the surface F2 of the projecting portion CN facing the ejection direction DN. Thus, the straightness of the liquid droplet ejected from the nozzle N is easily improved.

Specific examples of the liquid having a low surface tension, which is ejected from the nozzle N, include a liquid that contains an organic solvent represented by the following general formula (I) as a solvent.

R¹—O—(R²—O)₂—R³ (I)

where R¹ represents alkyl groups having 1 to 4 carbon atoms, R² represents ethylene groups or propylene groups, and R³ represents hydrogen atoms or alkyl groups having 1 to 4 carbon atoms. In the aspect described above, since the surface tension of the liquid using the glycol ether-based solvent represented by the general formula (I) as solvent is low, the effect of forming the liquid pool in a uniform wet state on the surface F2 of the projecting portion CN facing the ejection direction DN is remarkable.

Examples of the alkyl group having 1 to 4 carbon atoms include a linear or branched alkyl group, and specific examples thereof include a methyl group, an ethyl group, an N-propyl group, an iso-propyl group, an n-butyl group, a sec-butyl group, and a tert-butyl group.

The compounds represented by the general formula (I) may be used alone or in combination of two or more kinds thereof. The organic solvent represented by the general formula (I) is an alkylene glycol alkyl ether. The alkylene glycol alkyl ether can satisfactorily dissolve the fixing resin in a case where the ink composition is contained in the fixing resin.

Among the compounds represented by the general formula (I), specific examples of the compound having a flash point of 70 °C or lower include diethylene glycol methyl ethyl ether (flash point: 64 °C), diethylene glycol dimethyl ether (flash point: 56 °C), and dipropylene glycol dimethyl ether (flash point: 65 °C). These compounds may be used alone or in combination of two or more kinds thereof.

A wettable film 62 is provided on the surface F2 of the projecting portion CN facing the ejection direction DN. This can suitably form a liquid pool in a uniform wet state on the surface F2 of the projecting portion CN facing the ejection direction DN. Thus, the ejection bending can be suitably reduced.

In the present embodiment, the wettable film 62 is provided over the surface F2 of the projecting portion CN facing the ejection direction DN and the surfaces F1 of the protruding portions PR facing the ejection direction DN. With this configuration, the wettable film 62 provided on the surfaces F1 of the protruding portions PR facing the ejection direction DN allows the liquid to wet-spread also on the surfaces of the protruding portions PR, and thus the ejection bending can be suitably reduced. A constituent material of the wettable film 62 is not particularly limited as long as it can provide wettability. However, similarly to the wettable film 61, examples of the material include a monomolecular film having a hydroxy group or a carboxy group at a terminal and PPSi (polysiloxane). Between the wettable film 62 and the surface of the nozzle substrate 530, a protective layer formed of tantalum oxide or the like may be provided or an adhesion layer such as a silicon plasma polymerized film may be provided. Instead of the wettable film 62, a liquid repellent film such as a liquid repellent film 72 of a third embodiment (described later) may be provided on the surface F1 of the protruding portion PR facing the ejection direction DN.

On the nozzle surface FN of the nozzle substrate 530, a liquid repellent film 71 having liquid repellency is provided in a region not having the projecting portion CN. This configuration, which has the liquid repellent film 71 on the surface of the nozzle substrate 530 around the projecting portion CN, can reduce the possibility that the liquid will spread around the projecting portion CN on the nozzle substrate 530. This can suitably form a liquid pool in a uniform wet state on the surface F2 of the projecting portion CN facing the ejection direction DN. This also can further reduce the possibility that the liquid pool will be formed on the surface of the nozzle substrate 530.

The term “liquid repellency” means that the contact angle with pure water is 100 °or more. A constituent material of the liquid repellent film 71 is not particularly limited as long as it can provide liquid repellency. Examples of the material include a fluorine-based resin material, such as perfluoropolyether (PFPE) and a monomolecular film having a fluoro group at a terminal. The liquid repellent film 71 is preferably formed of a material that exhibits liquid repellency with respect to ink. For example, it is preferable that the angle of contact between the liquid repellent film 71 and the ink having a surface tension of about 25 Mn/m be 60 °or more.

A second nozzle section N2 is provided at a position opposite to the ejection direction DN with respect to the above-described first nozzle section N1.

The second nozzle section N2 is a hole located between the pressure chamber C1 and the first nozzle section N1. The diameter W2 of the second nozzle section N2 is larger than the diameter W1 of the first nozzle section N1. The second nozzle section N2 having such a configuration makes the liquid supply and replacement for the first nozzle section N1 easy.

In the illustrated example, the second nozzle section N2 has a circular shape in plan view. The shape of the second nozzle section N2 is not limited to the example illustrated in the drawings and may be appropriately determined. Furthermore, the second nozzle section N2 may be provided as needed or may be omitted.

The above-described nozzle N has a circle shape when the nozzle N is viewed in plan view in the ejection direction DN, and the distance between the inner side surface SD and the outer peripheral edge of the projecting portion CN in the radial direction of the nozzle N is the first width D1. Here, the first width D1 is smaller than the radius r of the nozzle N. As described above, since the first width D1 is smaller than the radius r of the nozzle N, even when the liquid attaches to the periphery of the opening of the nozzle N, this configuration can suitably reduce the possibility that the liquid will wet-spread from the opening of the nozzle N along the surface of the nozzle substrate 530. Thus, the ejection bending can be suitably reduced.

The first width D1 is preferably ⅛ or more and less than ½ with respect to the inner diameter 2 r (=W1) of the nozzle N. However, if the first width D1 is too small, the surface F2 of the projecting portion CN facing the ejection direction DN becomes narrow, making it difficult to uniformly form a liquid pool on the surface. In contrast, if the first width D1 is too large, the nozzle N itself increases in size, making it difficult to densely arrange the nozzles N.

When the nozzle N is viewed in plan view in the ejection direction DN, a second width Wp, which is the width of the protruding portion PR in a direction intersecting the direction in which the protruding portion PR protrudes, is narrower than the first width D1. This enables the nozzle N to have an enough space for ejecting the liquid.

The distance D2 between the ends of the protruding portions PR in the protruding direction is preferably smaller than the radius r of the nozzle N, more preferably ⅛ or less, and still more preferably about 1/16 of the circumferential length of the nozzle N. This can reduce the flow velocity of the liquid between the protruding portions PR. Thus, this configuration can further shorten the length of the tail at the time of ejection.

The height H of the projecting portion CN in the ejection direction DN is preferably smaller than the inner diameter 2 r of the nozzle N and ½ or more of the inner diameter 2 r of the nozzle N. As indicated in FIGS. 5 and 6, the height H is a distance in the ejection direction DN between the nozzle surface FN and the surface F2 of the projecting portion CN facing the ejection direction DN. Thus, the height H of the projecting portion CN is higher than the height of the mist or the liquid droplet attached to a portion of the surface of the nozzle substrate 530 not having the projecting portion CN. This can suitably form a liquid pool in a uniform wet state on the surface F2 of the projecting portion CN facing the ejection direction DN.

### 2. SECOND EMBODIMENT

Hereinafter, a second embodiment of the present disclosure will be described. In the embodiment illustrated below, elements having the same effects and functions as those of the first embodiment will be designated by the reference numerals used in the description of the first embodiment, and each of the elements will not be described in detail as appropriate.

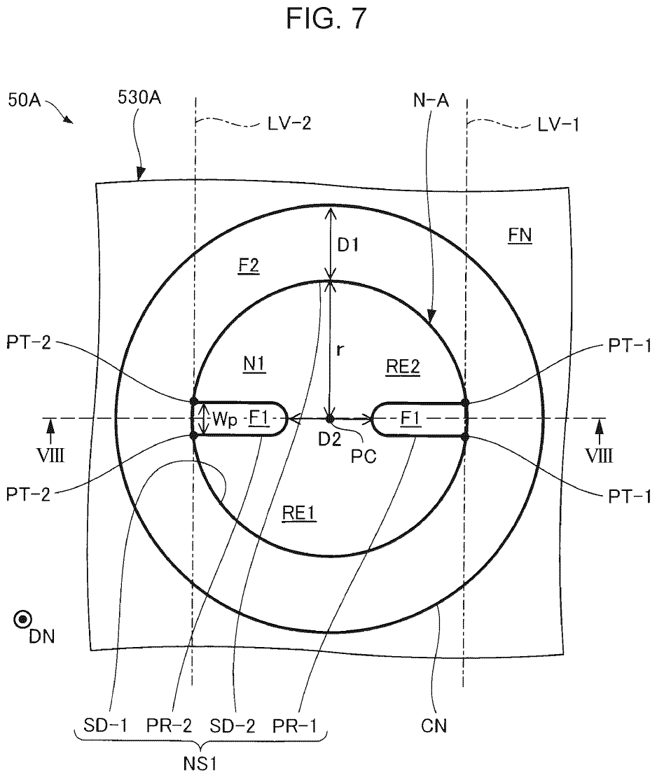

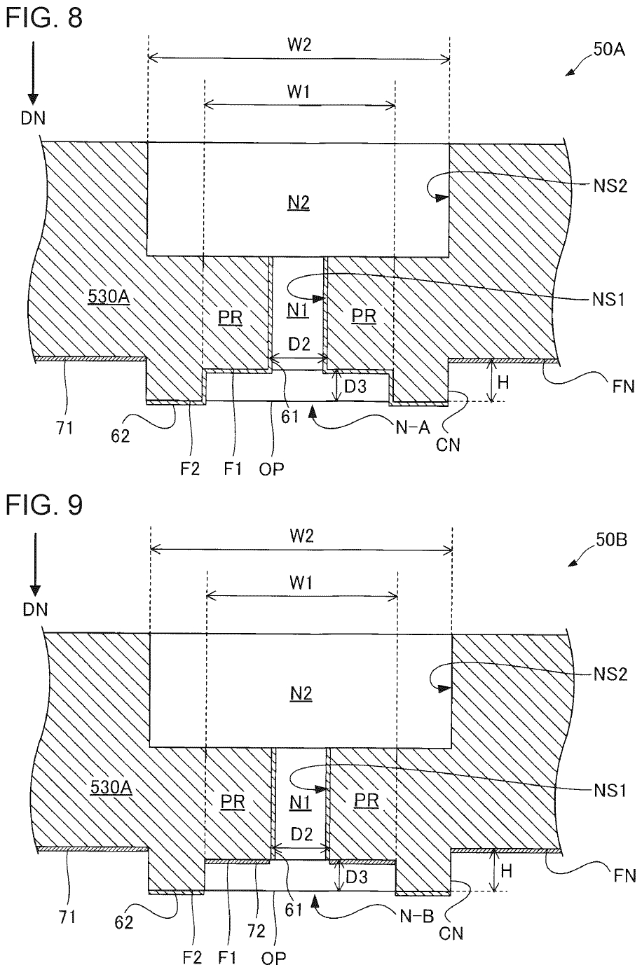

FIG. 7 is a view of a nozzle N-A according to the second embodiment as viewed in a direction opposite to the ejection direction DN. FIG. 8 is a cross-sectional view taken along line VIII-VIII in FIG. 7. A liquid ejecting head 50A according to the second embodiment has the same configuration as the liquid ejecting head 50 according to the first embodiment except that the liquid ejecting head 50A includes the nozzle N-A instead of the nozzle N.

The nozzle N-A has the same configuration as the nozzle N according to the first embodiment except that the surfaces F1 facing the ejection direction DN of the protruding portions PR are located in the first nozzle section N1.

As described above, in this embodiment, the surface F1 of each of the protruding portions PR facing the ejection direction DN is located upstream in the ejection direction DN of the surface F2 of the projecting portion CN facing the ejection direction DN. This can suitably form a liquid pool in a uniform wet state on the surface F2 of the projecting portion CN facing the ejection direction DN. In addition, for example, this can reduce the possibility that the protruding portion PR will be damaged by contact with a wiper or a wiping member when the nozzle substrate 530 is cleaned.

Here, a distance D3, which is a distance in the ejection direction DN between the surface F1 of the protruding portion PR facing the ejection direction DN and the surface F2 of the projecting portion CN facing the ejection direction DN, is preferably ⅛ or more and ½ or less of the inner diameter of the nozzle N. This can suitably form a liquid pool in a uniform wet state on the surface F2 of the projecting portion CN facing the ejection direction DN. In addition, for example, this can reduce the possibility that the protruding portion PR will be damaged by contact with a wiper or a wiping member when the nozzle substrate 530 is cleaned.

Furthermore, the distance D3, which is the distance in the ejection direction DN between the surface F1 of the protruding portion PR facing the ejection direction DN and the surface F2 of the projecting portion CN facing the ejection direction DN, is preferably smaller than the first width D1, more preferably about ½ of the first width D1, and still more preferably smaller than the height H of the projecting portion CN. This can further stabilize the position of meniscus.

The configuration of the second embodiment described above can also shorten the length of the tail when the liquid is ejected from the nozzle N-A and can increase the straightness of the liquid droplet ejected from the nozzle N-A.

### 3. THIRD EMBODIMENT

Hereinafter, a third embodiment of the present disclosure will be described. In the embodiment illustrated below, elements having the same effects and functions as those of the first embodiment will be designated by the reference numerals used in the description of the first embodiment, and each of the elements will not be described in detail as appropriate.

FIG. 9 is a cross-sectional view of a nozzle according to the third embodiment. A liquid ejecting head 50B according to the third embodiment has the same configuration as the liquid ejecting head 50A according to the second embodiment except that the liquid ejecting head 50B includes a nozzle N-B instead of the nozzle N-A.

The nozzle N-B has the same configuration as the nozzle N according to the second embodiment except that the liquid repellent film 72 is provided on the surface F1 of each protruding portion PR facing the ejection direction DN. As described above, the liquid repellent film 72, which is provided on the surface F1 of the protruding portion PR facing the ejection direction DN, can reduce the possibility that foreign matter such as dust or paper powder will attach to the protruding portion PR. In particular, in this embodiment in which the protruding portion PR is positioned inwardly from the surface of the projecting portion CN facing the ejection direction DN in the nozzle N-B, it is difficult to remove the foreign matter attached to the protruding portion PR, and thus it is advantageous to reduce attachment of foreign matter to the protruding portion PR.

The configuration of the third embodiment described above can also shorten the length of the tail when the liquid is ejected from the nozzle N-B and can increase the straightness of the liquid droplet ejected from the nozzle N-B.

### 4. MODIFICATIONS

Each of the above-described embodiments can be variously modified. Specific modifications that is applicable to the above-described embodiments will be described below. Two or more aspects appropriately selected from the following examples can be combined as appropriate to the extent that these aspects do not contradict each other.

### 4-1: Modification 1

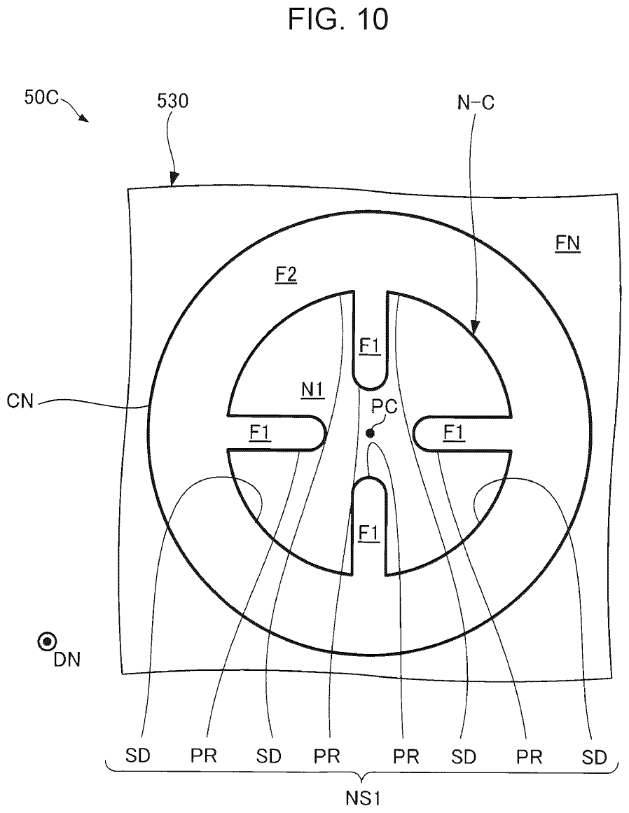

FIG. 10 is a view of a nozzle N-C according to a first modification viewed in the direction opposite to the ejection direction DN. A liquid ejecting head 50C according to the first modification has the same configuration as the liquid ejecting head 50 of the first embodiment except that the liquid ejecting head 50C has a nozzle N-C instead of the nozzle N.

The nozzle N-C has the same configuration as the nozzle N according to the first embodiment except that the number of protruding portions PR is four. In the illustrated example, four protruding portions PR are arranged at equal angular intervals in the circumferential direction around the central axis PC. The configuration of this first modification can also shorten the length of the tail when the liquid is ejected from the nozzle N-C and can increase the straightness of the liquid droplet ejected from the nozzle N-C.

The number of protruding portions PR is not limited to two or four and may be three or five or more. Furthermore, the cross-sectional shape of the first nozzle section N1 may be, for example, a trefoil, a quatrefoil, or a star.

### 4-2: Modification 2

The above-described embodiments describe the aspect in which the nozzle N has two sections having different diameters from each other. However, the present disclosure is not limited to this aspect, and the nozzle N may have only a first nozzle section having a constant width or a tapered shape, or the nozzle N may have three or more sections having different diameters from each other. That is, the above-described embodiment describes the aspect in which the nozzle N has the second nozzle section N2, but the disclosure is not limited to this aspect. The second nozzle section N2 may be omitted, or a third section or other sections having a different diameter from the first nozzle section N1 and the second nozzle section N2 may be added.

### 4-3: Modification 3

In each of the above-described embodiments, the serial liquid ejecting apparatus 100 in which the carriage 41 on which the liquid ejecting head 50 is mounted is reciprocated has been described as an example, but the present disclosure is also applicable to a line liquid ejecting apparatus having the nozzles N over the entire width of the recording medium M.

### 4-4: Modification 4

The liquid ejecting apparatus 100 described in the above-described embodiments may be used in not only an apparatus dedicated to printing but also various apparatuses such as a facsimile machine and a copier, and the application of the present disclosure is not particularly limited. However, the application of the liquid ejecting apparatus is not limited to printing. For example, a liquid ejecting apparatus that ejects a solution of a coloring material is used as a manufacturing apparatus that forms a color filter for a display device such as a liquid crystal display panel. In addition, a liquid ejecting apparatus that ejects a solution of a conductive material is used as a manufacturing apparatus that forms wiring lines and electrodes for a wiring substrate. In addition, a liquid ejecting apparatus that ejects a solution of an organic substance related to a living body is used, for example, as a manufacturing apparatus that manufactures biochips.

What is claimed is:

1. A liquid ejecting head comprising
a nozzle substrate having a nozzle configured to eject a liquid, wherein a direction in which the liquid is ejected from the nozzle is an ejection direction,
the nozzle substrate has a projecting portion along a periphery of an opening of the nozzle on a surface facing the ejection direction, and
the nozzle has a plurality of protruding portions that protrude toward a central axis of the nozzle from an inner side surface that is a portion of a side surface along the ejection direction.

2. The liquid ejecting head according to claim 1, wherein
when the nozzle is viewed in plan view in the ejection direction,
the nozzle has a circle shape,
a distance between the inner side surface and an outer peripheral edge of the projecting portion in a radial direction of the nozzle is a first width, and
the first width is smaller than a radius of the nozzle.

3. The liquid ejecting head according to claim 2, wherein
when the nozzle is viewed in plan view in the ejection direction,
a second width that is a width of each of the protruding portions in a direction intersecting a direction in which the plurality of protruding portions protrude is smaller than the first width.

4. The liquid ejecting head according to claim 1, wherein
a surface of each of the plurality of protruding portions facing the ejection direction is located upstream in the ejection direction of a surface of the projecting portion facing the ejection direction.

5. The liquid ejecting head according to claim 4, wherein
a distance in the ejection direction between the surface of each of the plurality of protruding portions facing the ejection direction and the surface of the projecting portion facing the ejection direction is ⅛ or more and ½ or less of an inner diameter of the nozzle.

6. The liquid ejecting head according to claim 1, further comprising a wettable film on a surface of the projecting portion facing the ejection direction.

7. The liquid ejecting head according to claim 6, further comprising
a liquid repellent film on a portion of a surface of the nozzle substrate located around the projecting portion.

8. The liquid ejecting head according to claim 1, further comprising
a wettable film on a surface of each of the plurality of protruding portions facing the ejection direction.

9. The liquid ejecting head according to claim 1, further comprising
a liquid repellent film on a surface of each of the plurality of protruding portions facing the ejection direction.

10. The liquid ejecting head according to claim 1, wherein
a height of the projecting portion in the ejection direction is smaller than an inner diameter of the nozzle and is ½ or more of the inner diameter of the nozzle.

11. The liquid ejecting head according to claim 1, wherein
the liquid to be ejected from the nozzle has a surface tension of 10 mN/m or more and 30 mN/m or less.

12. The liquid ejecting head according to claim 1, wherein
the liquid to be ejected from the nozzle contains an organic solvent represented by a following general formula (I) as a solvent:
R¹—O—(R²—O)₂—R³ (I)
where R¹ represents alkyl groups having 1 to 4 carbon atoms, R² represents ethylene groups or propylene groups, and R³ represents hydrogen atoms or alkyl groups having 1 to 4 carbon atoms.
